(19) United States
(12) Patent Application Publication
(10) Pub. No.: US 2016/0006019 A1
(43) Pub. Date: Jan. 7, 2016

(54) CARBON-SILICON COMPOSITE AND MANUFACTURING MEHTOD OF THE SAME

(71) Applicant: OCI COMPANY LTD., Seoul (KR)

(72) Inventors: Sung-Ho JUNG, Seongnam-si (KR); Yo-Seop KIM, Seongnam-si (KR); Eun-Hye JEONG, Seongnam-si (KR); Jeong-Hyun HA, Seongnam-si (KR)

(21) Appl. No.: 14/788,797

(22) Filed: Jul. 1, 2015

(30) Foreign Application Priority Data
Jul. 3, 2014 (KR) 10-2014-0083301

(51) Int. Cl. H01M 4/04; H01M 4/38; H01M 4/583; H01M 4/36

(52) U.S. Cl. CPC H01M 4/0471; H01M 4/364; H01M 4/386; H01M 4/583; H01M 2004/027

(57) ABSTRACT

Disclosed herein are a manufacturing method of a carbon-silicon composite, comprising: (a) preparing a silicon-polymer matrix slurry comprising a silicon slurry, a monomer, and a cross-linking agent; (b) performing a heat treatment on the silicon-polymer matrix slurry to manufacture a silicon-polymer carbonized matrix; (c) pulverizing the silicon-polymer carbonized matrix to manufacture silicon-polymer carbonized particles; and (d) mixing the silicon-polymer carbonized particles with a first carbon raw material, and then performing a carbonization process, the carbon-silicon composite, an anode for a secondary battery manufactured by applying the carbon-silicon composite, and a secondary battery comprising the anode for a secondary battery.

### CROSS REFERENCE TO RELATED APPLICATION

This application claims the benefit of Korean Patent Application No. 10-2014-0083301, filed on Jul. 3, 2014, entitled “CARBON-SILICON COMPOSITE AND MANUFACTURING METHOD OF THE SAME”, which is hereby incorporated by reference in its entirety into this application.

### TECHNICAL FIELD

The present invention relates to a carbon-silicon composite and a manufacturing method thereof.

### BACKGROUND ART

An anode material of a lithium secondary battery capable of implementing high capacity is required to be used for a battery for an information technology (IT) equipment or a battery for an automobile. Accordingly, silicon has attracted attention as the anode material of the lithium secondary battery with high capacity. For example, it is known that pure silicon has a high theoretical capacity of 4,200 mAh/g.

However, when inorganic particles such as silicon for an anode active material are directly used as a material for absorption and release of lithium, conductivity between active materials is deteriorated due to a change in volume during a charge and discharge process, or the anode active material is separated from an anode current collector, so that inorganic particles have poor charge capacity and capacity retention as compared with a carbon-based material. That is, inorganic particles such as silicon comprised in the anode active material absorb lithium by a charge process, so that inorganic particles expand about 300% to 400% in volume. In addition, when the lithium is released by a discharge process, the inorganic particles contract, and when the charge and discharge cycles are repeated, electrical insulation may occur due to empty space generated between the inorganic particles and the anode active material to cause decrease in charge capacity and capacity retention, and therefore, the inorganic particles have a serious problem in being used for a secondary battery.

### DISCLOSURE

### Technical Problem

In order to further improve charge capacity and capacity retention of a secondary battery, an aspect of the present invention is to provide a carbon-silicon composite as an anode active material for a secondary battery, and a manufacturing method of the carbon-silicon composite, the manufacturing method comprising: (a) preparing a silicon-polymer matrix slurry from mixture comprising a silicon slurry, a monomer, and a cross-linking agent; (b) performing a heat treatment on the silicon-polymer matrix slurry to manufacture a silicon-polymer carbonized matrix; (c) pulverizing the silicon-polymer carbonized matrix to manufacture silicon-polymer carbonized particles; and (d) mixing the silicon-polymer carbonized particles with a first carbon raw material, and then performing a carbonization process.

### Technical Solution

In accordance with one aspect of the present invention, there is provided a carbon-silicon composite as an anode active material for a secondary battery, and a manufacturing method of the carbon-silicon composite, the manufacturing method comprising: (a) preparing a silicon-polymer matrix slurry from mixture comprising a silicon slurry, a monomer, and a cross-linking agent; (b) performing a heat treatment on the silicon-polymer matrix slurry to manufacture a silicon-polymer carbonized matrix; (c) pulverizing the silicon-polymer carbonized matrix to manufacture silicon-polymer carbonized particles; and (d) mixing the silicon-polymer carbonized particles with a first carbon raw material, and then performing a carbonization process.

When it is assumed that a particle diameter at 50% cumulative mass particle size distribution is D50, silicon (Si) in the silicon-polymer matrix slurry in (a) may satisfy 2 nm<D50<180 nm.

The monomer in (a) is at least one selected from the group consisting of acrylic add, acrylate, methyl methacrylic add, methyl methacrylate, acryamide, vinyl acetate, maleic add, styrene, acrylonitrile, phenol, ethylene glycol, lauryl methacrylate, and vinyl difluoride.

The cross-linking agent in (a) may be at least one selected from the group consisting of ethylene glycol dimethacrylate, ethylene glycol diacrylate, diethylene glycol dimethacrylate, diethylene glycol diacrylate, triethylene glycol diacrylate, tetraethylene glycol diacrylate, N,N-methylenebisacrylamide, N,N-(1,2-dihydroxyethylene)bisacrylamide, and divinylbenzene.

The silicon slurry, the monomer, and the cross-linking agent in (a) may have a weight ratio of 10:5˜10:1˜5.

The heat treatment in (b) may be performed under an atmospheric pressure at 300° C. to 500° C. for 0.5 to 5 hours.

The silicon-polymer carbonized matrix in (b) may have a polymer network structure formed by cross-linking between monomers.

The first carbon raw material in (d) may comprise at least one selected from the group consisting of natural graphite, artificial graphite, soft carbon, hard carbon, pitch, calcined coke, graphene, carbon nanotube, and combinations thereof.

The manufacturing method may further comprise: (e) mixing the carbon-silicon composite with a second carbon raw material, and then performing a carbonization process.

The second carbon raw material in (e) may comprise at least one selected from the group consisting of natural graphite, artificial graphite, soft carbon, hard carbon, pitch, calcined coke, graphene, carbon nanotube, and combinations thereof.

In accordance with another aspect of the present invention, there is provided a carbon-silicon composite comprising: silicon-polymer carbonized particles formed from a mixture comprising a silicon slurry, a monomer, and a cross-linking agent; and a first carbon matrix, wherein the silicon-polymer carbonized particles are captured and dispersed in the first carbon matrix.

A mass ratio of silicon (Si) to carbon (C) in the carbon-silicon composite may be 1:99 to 10:90.

The silicon-polymer carbonized particle may be with higher porosity than that of the first carbon matrix.

The first carbon matrix may comprise at least one selected from the group consisting of natural graphite, artificial graphite, soft carbon, hard carbon, pitch carbide, calcined coke, graphene, carbon nanotube, and combinations thereof.

The carbon-silicon composite may further comprise: second carbon particles.

The second carbon particle may comprise at least one selected from the group consisting of natural graphite, artificial graphite, soft carbon, hard carbon, pitch carbide, calcined coke, graphene, carbon nanotube, and combinations thereof.

In accordance with another aspect of the present invention, there is provided an anode for a secondary battery manufactured by coating an anode slurry onto an anode current collector, the anode slurry comprising: the carbon-silicon composite as described above; a conductive material; a binder; and a thickening agent.

In accordance with another aspect of the present invention, there is provided a secondary battery comprising the anode for a secondary battery as described above.

### Advantageous Effects

The silicon-polymer matrix slurry according to the present invention may comprise significantly uniformly dispersed silicon (Si) therein, and the silicon-polymer carbonized matrix formed from the silicon-polymer matrix slurry may have a polymer network structure formed by cross-linking between monomors, such that when the carbon-silicon composite comprising the silicon-polymer carbonized matrix is used for an anode active material for a secondary battery, charge capacity and capacity retention of the secondary battery may be improved.

### DESCRIPTION OF DRAWINGS

The above and other aspects, features, and advantages of the present invention will become apparent from the detailed description of the following embodiments in conjunction with the accompanying drawings, in which:

FIG. 1 shows energy-dispersive spectroscopy (EDS) images of silicon (Si) in the carbon-silicon composites manufactured by Example 1 and Comparative Example 1.

FIG. 2 is scanning electron microscope (SEM) images of cross-sections cut by focus on beam (FIB) of anodes for secondary battery according to Example 1 and Comparative Example 1.

FIG. 3 exhibits discharge capacity with respect to repeated cycles of the secondary batteries manufactured by Example 1 and Comparative Examples 1 and 2.

### BEST MODE

Hereinafter, exemplary embodiments of the present invention will be described in detail. However, the following examples are only provided as one embodiment of the present invention, and the present invention is not limited to the following Examples.

Manufacturing Method of Carbon-Silicon Composite

The present invention provides a manufacturing method of a carbon-silicon composite, comprising: a manufacturing method of the carbon-silicon composite, the manufacturing method comprising: (a) preparing a silicon-polymer matrix slurry from mixture comprising a silicon slurry, a monomer, and a cross-linking agent; (b) performing a heat treatment on the silicon-polymer matrix slurry to manufacture a silicon-polymer carbonized matrix; (c) pulverizing the silicon-polymer carbonized matrix to manufacture silicon-polymer carbonized particles; and (d) mixing the silicon-polymer carbonized particles with a first carbon raw material, and then performing a carbonization process.

(a) is a preparing step for the silicon-polymer matrix slurry from mixture comprising the silicon slurry, the monomer, and the cross-linking agent. The silicon-polymer matrix slurry may be prepared by mixing the silicon slurry, the monomer and the cross-linking agent, and then by cross-linking between monomers.

Here, the silicon-polymer matrix slurry refers to a slurry comprising significantly uniformly dispersed silicon (Si) in polymer matrix.

The silicon slurry refers to a slurry comprising silicon particles and a dispersion medium, wherein the silicon particles may have a spherical shape with a diameter of 2 nm to 200 nm.

The dispersion medium is a solvent for improving dispersibility and stability of the silicon slurry and the solvent is preferably at least one selected from the group consisting of N-methyl-2-pyrrolidone (NMP), tetrahydrofuran (THF), water, methanol, ethanol, cyclohexanol, cyclohexanone, methyl ethyl ketone, acetone, dimethyl sulfoxide (DMSO) and combinations thereof, more preferably, NMP or THF is used as the solvent for improving dispersibility and stability.

The monomer is a starting material for forming a polymer, and serves as a buffer for silicon. The monomer is preferably at least one selected from the group consisting of acrylic acid, acrylate, methyl methacrylic acid, methyl methacrylate, acryamide, vinyl acetate, maleic acid, styrene, acrylonitrile, phenol, ethylene glycol, lauryl methacrylate, and vinyl difluoride, but is not limited thereto. In the present invention, acrylic acid was used as the monomer.

The cross-linking agent serves to allow a polymer formed from the monomer to cross-link each other so that the silicon-polymer matrix particles have a polymer network structure. The cross-linking agent is preferably at least one selected from the group consisting of ethylene glycol dimethacrylate, ethylene glycol diacrylate, diethylene glycol dimethacrylate, diethylene glycol diacrylate, triethylene glycol diacrylate, tetraethylene glycol diacrylate, N,N-methylenebisacrylamide, N,N-(1,2-dihydroxyethylene)bisacrylamide, and divinylbenzene, but is not limited thereto. In the present invention, ethylene glycol dimethacrylate was used as the cross-linking agent.

The silicon-polymer matrix slurry may further comprise an additive. Here, an initiator used as the additive may be a radical polymerization initiator. The initiator is preferably at least one selected from the group consisting of 1,1′-azobis(cyclohexanecarbonitrile) (ABCN), azobisisobutyronitrile (AIBN), benzophenone, 2,2-dimethoxy-2-phenyl acetophenone and benzoyl peroxide, but is not limited thereto. In the present invention, 1,1′-azobis(cyclohexanecarbonitrile) (ABCN) was used as the radical polymerization initiator.

The silicon-polymer matrix in the silicon-polymer matrix slurry may have a polymer network structure formed by cross-linking between monomers. In the present specification, ‘the polymer network structure’ refers to a structure designed as a micro model of an amorphous polymer material with a cross-linking point, which consists of knots and chains connecting knots.

Here, silicon is dispersed in the polymer matrix with the polymer network structure, and the polymer matrix with the polymer network structure is appropriate for a material serving as a buffer for silicon.

In addition, due to the network structure of polymer matrix, silicon may be significantly uniformly dispersed in the silicon-polymer matrix slurry. Here, the polymer matrix may be formed in a gel type matrix.

In addition, when it is assumed that a value of a particle diameter at 50% in cumulative distribution is D50, silicon (Si) in the silicon-polymer matrix slurry preferably satisfies 2 nm<D50<180 nm. Here, the polymer matrix has a polymer network structure formed by cross-linking between monomers, such that as compared to silicon particle slurry, the silicon-polymer matrix slurry has enhanced silicon dispersibility to reduce agglomeration between particles. Therefore, size deviation between particles is small and silicon has a small range of D50, as a result, the silicon-polymer carbonized matrix may be more uniformly dispersed in the first carbon matrix.

The silicon slurry, the monomer, and the cross-linking agent may preferably have a weight ratio of 10:5˜10:1˜5, more preferably, a weight ratio of 10:5:1, but the present invention is not limited thereto.

(b) is a heat treatment step on the silicon-polymer matrix slurry for manufacturing the silicon-polymer carbonized matrix.

The silicon-polymer matrix slurry is carbonized by heat treatment, so that the silicon-polymer carbonized matrix is manufactured.

That is, the silicon-polymer carbonized matrix has a polymer network structure formed by cross-linking between monomers, such that in a process for manufacturing the composite by using the silicon-polymer carbonized particles together with the first carbon matrix, the silicon-polymer carbonized particles may be uniformly dispersed in the first carbon matrix without agglomerating the silicon-polymer carbonized particles with each other.

Therefore, when an anode active material for a secondary battery is prepared from the silicon-polymer carbonized matrix according to the present invention, the secondary battery may remarkably increase an initial charge capacity and capacity retention.

In addition, the heat treatment may be performed at a temperature of 50° C. to 600° C., under pressure ranging from 0.5 bar to 10 bar. If necessary, the heat treatment may be performed by one stage or by multiple stages. Preferably, the heat treatment may be performed under an atmospheric pressure at 300° C. to 500° C. for 0.5 to 5 hours, more preferably, under an atmospheric pressure at 400° C. for 1 hour.

(c) is a pulverizing step for the silicon-polymer carbonized matrix to manufacture silicon-polymer carbonized particles, wherein the silicon-polymer carbonized matrix may be pulverized so that the silicon-polymer carbonized particles are uniformly mixed with a first carbon raw material.

The step (d) is a step of mixing the silicon-polymer carbonized particles with the first carbon raw material, and then performing a carbonization process.

The first carbon raw material preferably comprises at least one selected from the group consisting of natural graphite, artificial graphite, soft carbon, hard carbon, pitch, calcined coke, graphene, carbon nanotube, and combinations thereof, but is not limited thereto. Specifically, as the first carbon raw material, commercially available coal tar pitch or petroleum pitch may be generally used. The first carbon raw material is carbonized by the subsequent carbonization process to be formed as a carbon matrix comprising crystalline carbon, amorphous carbon, or both of crystalline carbon and amorphous carbon. Additionally, conductive or non-conductive carbon raw materials may be used as the first carbon raw material.

The silicon-polymer carbonized particles may be mixed with the first carbon raw material in the mixed solution so that a mass ratio of silicon (Si) to carbon (C) is 1:99 to 10:90. When the carbon-silicon composite manufactured as above described mass ratio, a volume expansion in a charge and discharge process may be alleviated to improve charge capacity and capacity retention.

In the present invention, the carbonization process refers to a process of firing a carbon raw material at a high temperature to leave carbon, and by the carbonization process, the first carbon matrix is formed from the first carbon raw material.

For example, the first carbon matrix may have a carbonization yield of 40 wt % to 80 wt % in the carbonization process. By increasing the carbonization yield of the carbonization process, generation of volatile matter may be reduced, and the process for manufacturing the carbon-silicon composite can be environmentally friendly process.

The carbonization process may be performed by heat-treating the mixed solution at a temperature of 400° C. to 1400° C., under pressure ranging from 1 bar to 15 bar, and for 1 to 24 hours. If necessary, the carbonization process may be performed by one stage or by multiple stages.

The manufacturing method may further comprise: (e) mixing the carbon-silicon composite with a second carbon raw material, and then performing a carbonization process.

Here, The second carbon raw material preferably comprises at least one selected from the group consisting of natural graphite, artificial graphite, soft carbon, hard carbon, pitch carbide, calcined coke, graphene, carbon nanotube, and combinations thereof, but is not limited thereto.

The second carbon particles may be formed from the second carbon raw material by the carbonization process, and specific conditions of the carbonization process are the same as described in (d).

Carbon-Silicon Composite

In addition, the present invention provides a carbon-silicon composite comprising: a silicon-polymer carbonized particles formed from a silicon-polymer matrix slurry comprising a silicon slurry, a monomer, and a cross-linking agent; and a first carbon matrix, wherein the silicon-polymer carbonized particles are captured and dispersed in the first carbon matrix.

The first carbon matrix is formed from a first carbon raw material, preferably comprises at least one selected from the group consisting of natural graphite, artificial graphite, soft carbon, hard carbon, pitch carbide, calcined coke, graphene, carbon nanotube, and combinations thereof, but is not limited thereto.

In the carbon-silicon composite, the silicon-polymer carbonized particles formed from a mixture comprising a silicon slurry, a monomer, and a cross-linking agent may not agglomerate with each other, so that the silicon-polymer carbonized particles are uniformly dispersed in the first carbon matrix.

When the carbon-silicon composite is applied for an anode active material for a secondary battery, a volume expansion in a charge and discharge process may be alleviated. Thus, by exhibiting high capacity of silicon property, charge capacity and capacity retention of the secondary battery can be improved.

The carbon-silicon composite having uniformly dispersed silicon-polymer carbonized particles may exhibit enhanced capacity even though it comprises the same content of silicon. For example, the carbon-silicon composite may exhibit a capacity over about 80% of a theoretical capacity of silicon.

Specifically, the carbon-silicon composite may be formed in spherical or spherical-like particles, and may have a particle diameter of 0.5 μm to 50 μm. When the carbon-silicon composite having the above-described range of particle size is applied for an anode active material for a secondary battery, charge capacity may be effectively exhibited due to the high capacity of silicon property and a volume expansion problem in a charge and discharge process may be alleviated to improve capacity retention of the secondary battery.

The carbon-silicon composite may have a mass ratio of silicon (Si) to carbon (C) of 1:99 to 10:90. The carbon-silicon composite has an advantage of containing a high content of silicon within the above-described numerical scope, and also may comprise the uniformly dispersed silicon-polymer carbonized particles while containing the high content of silicon, such that a volume expansion problem caused in a charge and discharge process at the time of using the silicon as the anode active material, may be alleviated.

For example, the carbon-silicon composite rarely comprises oxides which are possible to deteriorate performance of the secondary battery, such that an oxygen content of the carbon-silicon composite is significantly low. Specifically, the carbon-silicon composite may have an oxygen content of 0 wt % to 1 wt %. In addition, the first carbon matrix rarely comprises other impurities and by-product compounds, and mostly consists of carbon. Specifically, the first carbon matrix may have a carbon content of 70 wt % to 100 wt %.

As described above, in the carbon-silicon composite, the silicon-polymer carbonized particles are dispersed throughout an inner region of the first carbon matrix, that is, the silicon-polymer carbonized particles are uniformly dispersed and present inside of the first carbon matrix as well as at a surface side thereof. Specifically, the description that the silicon-polymer carbonized particles are uniformly dispersed and present inside means that the silicon-polymer carbonized particles are captured and present inside over a depth corresponding to 5% of a radius of the carbon-silicon composite. More specifically, since the silicon-polymer carbonized particles are present at a depth corresponding to 1% to 100% of the radius of the carbon-silicon composite, the carbon-silicon composite according to the present invention is differentiated from a carbon-silicon composite in which silicon-polymer carbonized particles are dispersed only at a surface side at a depth corresponding to less than 5% of the radius. Obviously, the description that the silicon-polymer carbonized particles are present at a depth corresponding to 1% to 100% of the radius of the carbon-silicon composite does not exclude a case in which the silicon-polymer carbonized particles are present at a depth corresponding to 0% to 1% of the radius of the carbon-silicon composite.

In addition, since it is general that the silicon-polymer carbonized particles used as raw materials at the time of performing a carbonization process agglomerate to be a lump, the carbon-silicon composite may comprise silicon-polymer carbonized matrix lump particles formed by agglomerating the silicon-polymer carbonized particles.

In the present specification, the description that the silicon-polymer carbonized particles are uniformly dispersed means that the silicon-polymer carbonized particles are uniformly dispersed throughout the first carbon matrix, and means that the silicon-polymer carbonized matrix lump particles are uniformly formed, which has a small deviation value in view of a statistical analysis of a particle diameter of the silicon-polymer carbonized matrix lump particles, and specifically, means that the maximum value of a diameter of the silicon-polymer carbonized matrix lump particle may correspond to a predetermined level or less.

That is, since the silicon-polymer carbonized particles are uniformly dispersed in the carbon-silicon composite, the silicon-polymer carbonized matrix lump particles are also relatively decreased. Specifically, the silicon-polymer carbonized matrix lump particles formed by agglomerating the silicon-polymer carbonized particles in the first carbon matrix may be formed to have a diameter of 20 μm or less.

In addition, in a case of the polymer matrix particle, during a carbonization process, other impurities and by-product compound such as oxygen, hydrogen, or the like, except for carbon in the polymer matrix particles are not carbonized but vaporized, such that space of other impurities and by-product compound such as oxygen, hydrogen, or the like, except for carbon, remain as an empty space, and therefore, the polymer carbonized matrix particles may be with higher porosity than that of the first carbon matrix mostly consisting of carbon only.

Specifically, the polymer matrix particles preferably have a carbonization yield of 5% to 30%, and the first carbon matrix preferably has a carbonization yield 40% to 80%, but the present invention is not limited thereto. The first carbon matrix rarely comprises other impurities and by-product compound, but mostly consists of carbon only, such that a carbonization yield in a carbonization process is remarkably excellent. The polymer matrix particles comprise other impurities and by-product compound such as oxygen, hydrogen, or the like, except for carbon, such that a carbonization yield in the carbonization process is deteriorated.

In the present specification, a diameter of a particle refers to a distance between two points defined upon contacting a straight line passing the center of the particle with a surface of the particle.

The diameter of the particle may be measured by various methods according to known methods, for example, may be measured by using X-ray diffraction (XRD) or by analyzing scanning electron microscope (SEM) images.

In addition, the carbon-silicon composite may be formed in a spherical shape or in a spherical-like shape, and may be formed to have a spherical shape (that is, may be spheronized) together with the second carbon particles. Here, pores may be formed between the carbon-silicon composite and the second carbon particles.

In order to spheronize the carbon-silicon composite and the second carbon particles, known various methods and devices may be used.

The second carbon matrix is formed from a second carbon raw material, preferably comprises at least one selected from the group consisting of natural graphite, artificial graphite, soft carbon, hard carbon, pitch carbide, calcined coke, graphene, carbon nanotube, and combinations thereof, but is not limited thereto.

Preferably, the first carbon matrix is amorphous carbon, and the second carbon particle may be crystalline carbon. For example, in a case in which the second carbon particle is graphite, the second carbon particle may have a plate shape or a fragment shape, and may be spheronized together with the carbon-silicon composite formed in a spherical shape, such that the spherical carbon-silicon composite may be spheronized in a state of being captured and dispersed between the layered second carbon particles. Specifically, in a case in which the second carbon particle is graphite, the second carbon particle may have a plate shape or a fragment shape in which an average diameter is 0.5 μm to 500 μm, and a thickness is 0.01 μm to 100 μm, on a flat plane.

The carbon-silicon composite may further comprise an amorphous carbon coating layer as an outermost layer.

Anode for Secondary Battery

The present invention provides an anode for a secondary battery in which an anode slurry is coated on an anode current collector, the anode slurry comprising: the carbon-silicon composite as described above; a conductive material; a binder; and a thickening agent.

The anode for a secondary battery is formed by coating the anode slurry comprising the carbon-silicon composite; a conductive material; a binder; and a thickening agent on an anode current collector, followed by drying and rolling.

As the conductive material, at least one selected from the group consisting of a carbon-based material, a metal material, a metal oxide, and an electrically conductive polymer may be used. Specifically, carbon black, acetylene black, Ketjen black, furnace black, carbon fiber, fullerene, copper, nickel, aluminum, silver, cobalt oxide, titanium oxide, a polyphenylene derivative, polythophene, polyacene, polyacetylene, polypyrrole, polyaniline, and the like, may be used.

As the binder, various kinds of binder polymers such as styrene-butadiene rubber (SBR), carboxymethyl cellulose (CMC), vinylidene fluoride-hexafluoropropylene copolymer (PVDF-co-HFP), polyvinylidenefluoride, polyacrylonitrile, polymethylmethacrylate, and the like, may be used. The thickening agent is to control viscosity, and may comprise carboxymethyl cellulose, hydroxymethyl cellulose, hydroxyethyl cellulose, hydroxypropyl cellulose, and the like.

As the anode current collector, stainless steel, nickel, copper, titanium, or alloys thereof, and the like, may be used. Among them, copper or copper alloy is the most preferred.

Secondary Battery

The present invention provides a secondary battery comprising the anode for a secondary battery as described above.

The carbon-silicon composite in which the silicon-polymer carbonized particles in a nano size are significantly uniformly dispersed and comprised as an anode active material for a secondary battery is used in the secondary battery, such that the secondary battery may have more improved charge capacity and capacity retention.

The secondary battery comprises the anode for a secondary battery; a cathode comprising a cathode active material; a separator; and an electrolyte.

As materials used as the cathode active material, compounds capable of absorbing and releasing lithium, such as LiMn₂O₄, LiCoO₂, LiNIO₂, LiFeO₂, and the like, may be used.

As the separator insulating the electrodes between the anode and the cathode, olefin-based porous films such as polyethylene, polypropylene, and the like, may be used.

In addition, the electrolyte may be obtained by mixing and dissolving at least one electrolyte comprising lithium salt selected from the group consisting of LiPF₆, LiBF4, LiSbF₆, LiAsF₆, LiClO₄, LiCF₃SO₃, Li(CF₃SO₂)₂N, LiC₄F₉SO₃, LiSbF₆, LiAlO₄, LiAlCl₄, LiN(CₓF₂ₓ+1SO₂)(C_{y}F_{2y}+1SO₂) (provided that each of x and y is a natural number), LiCl, and LiI in at least one aprotic solvent selected from the group consisting of propylene carbonate, ethylene carbonate, butylene carbonate, benzonitrile, acetonitrile, tetrahydrofuran, 2-methyl tetrahydrofuran, γ-butyrolactone, dioxolane, 4-methyldioxolane, N,N-dimethylformamide, dimethylacetamide, dimethylsulfoxide, dioxane, 1,2-dimethoxyethane, sulfolane, dichloroethane, chlorobenzene, nitrobenzene, dimethyl carbonate, methyl ethyl carbonate, diethyl carbonate, methyl propyl carbonate, methyl isopropyl carbonate, ethyl propyl carbonate, dipropyl carbonate, diisopropyl carbonate, dibutyl carbonate, diethylene glycol, and dimethyl ether.

A plurality of secondary batteries may be electrically connected to each other to provide a middle- or large-sized battery module or a battery pack comprising the plurality of secondary batteries, wherein the middle- or large-sized battery module or the battery pack may be used as a power supply for at least any one middle- or large-sized device selected from power tools; electric vehicles comprising EV, hybrid electric vehicle (HEV), and plug-in hybrid electric vehicle (PHEV); electric trucks; electric commercial vehicles; or systems for energy storage.

Hereinafter, preferred embodiments of the present invention will be described to assist in understanding the present invention. However, the following exemplary embodiments are provided only to more easily understand the present invention. The present invention is not limited thereto.

### EXAMPLE

### Example 1

### Manufacture of Silicon-Polymer Carbonized Particles

A silicon slurry was prepared by dispersing 1 g of silicon particles having an average particle size of 50 nm in 9 g of N-methyl-2-pyrrolidone (NMP) serving as a dispersion medium. 5 g of an acrylic acid, 1 g of ethylene glycol dimethacrylate, and 0.5 g of 1,1′-azobis(cyclohexanecarbonitrile) were added to the prepared silicon slurry, followed by stirring at a temperature of 70° C. for 12 hours, thereby preparing a silicon-polymer matrix slurry.

Here, as a result obtained by measuring a silicon distribution property on the silicon-polymer matrix slurry by a dynamic light scattering method (measurement device: ELS-Z2 manufactured by Otsuka Electronics), D50 was 120 nm.

On the prepared silicon-polymer matrix slurry, a heat treatment was additionally performed in an electric furnace at a temperature of 400° C. for 1 hour to manufacture silicon-polymer carbonized matrix, and the silicon-polymer carbonized matrix was pulverized at 250 rpm for 30 minutes by using a planetary mill to manufacture silicon-polymer carbonized particles.

Manufacture of Carbon-Silicon Composite

The silicon-polymer carbonized particles were mixed with a particle shape of coal-based pitch evaporated at 350° C. for about 12 hours. The coal-based pitch and the silicon-polymer carbonized particles were mixed at a weight ratio of 97.5:2.5. Then, a carbonization process was performed at a temperature of 900° C. for 5 hours by raising a temperature at a rate of 10° C./min to form a carbon-silicon composite. The formed carbon-silicon composite was pulverized at 250 rpm for 1 hour by using a planetary mill, followed by a sorting process, to obtain powder only with selected particles each having a particle size of 50 μm or less.

Manufacture of Anode for Secondary Battery

A composition for an anode slurry was prepared by using the carbon-silicon composite powder as an anode active material, and mixing the anode active material, carbon black, carboxymethyl cellulose (CMC), and styrene butadiene (SBR) at a weight ratio of 91:5:2:2 with water. The composition for an anode slurry was coated on a copper current collector, and dried and rolled in an oven at 110° C. for about 1 hour, to manufacture an anode for a secondary battery.

Manufacture of Secondary Battery

A coin cell-type secondary battery was manufactured by stacking the anode for a secondary battery, a separator, an electrolyte (a solvent obtained by mixing ethylene carbonate with dimethyl carbonate at a weight ratio of 1:1 and adding 1.0M LiPF₆ thereto), and a lithium electrode.

### Comparative Example 1

Carbon-silicon composite powder, and an anode for a secondary battery and a secondary battery to which the carbon-silicon composite powder is applied were manufactured by the same method as Example 1, except for using a silicon slurry alone instead of using the silicon-polymer matrix slurry.

### Comparative Example 2

Carbon-silicon composite powder, and an anode for a secondary battery and a secondary battery to which the carbon-silicon composite powder is applied were manufactured by the same method as Example 1, except for using a coal-based pitch evaporated at 350° C. alone instead of using the silicon-polymer composite powder.

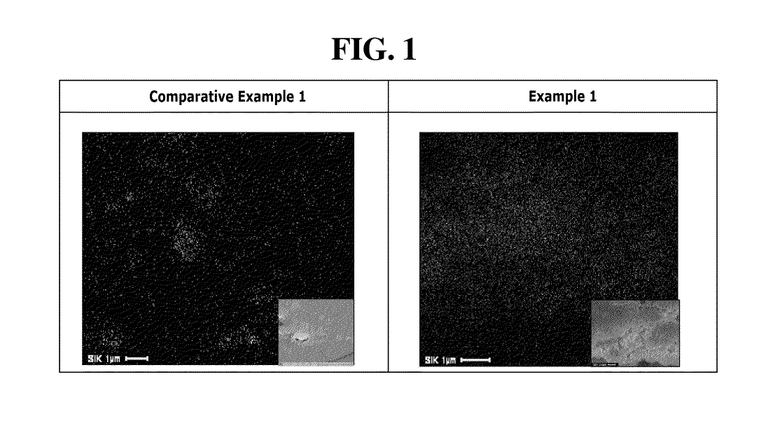

FIG. 1 shows energy-dispersive spectroscopy (EDS) images on silicon (Si) of the carbon-silicon composites manufactured by Example 1 and Comparative Example 1, observed by EDS.

As shown in FIG. 1, as results obtained by measuring the carbon-silicon composites by energy dispersive spectroscopy, it could be confirmed that the carbon-silicon composite manufactured by Example 1 comprised silicon and carbon at a weight ratio of 2.5:97.5 (Si:C). In addition, it could be confirmed that the silicon-polymer carbonized particles were entirely uniformly dispersed in the first carbon matrix, such that the silicon-polymer carbonized matrix lump particles were formed to have a particle size of about 20 μm or less.

Meanwhile, it could be confirmed that the carbon-silicon composite manufactured by Comparative Example 1 comprised silicon and carbon at a weight ratio of 2.5:97.5 (Si:C). In addition, it could be confirmed that the silicon-polymer carbonized particles agglomerated in the first carbon matrix, such that the silicon-polymer carbonized matrix lump particles were formed to have a particle size more than about 20 μm.

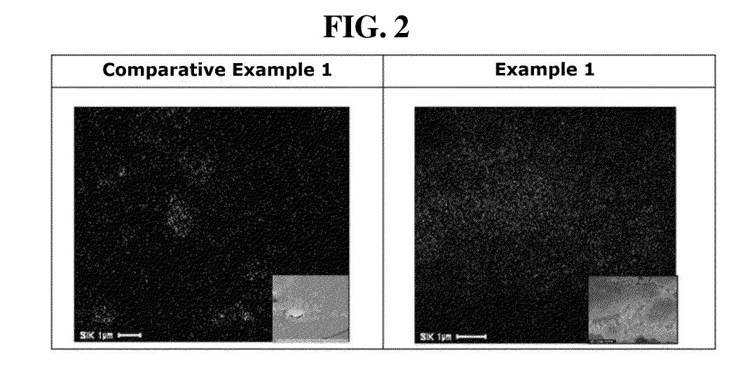

FIG. 2 is scanning electron microscope (SEM) images of cross-sections cut by focus ion beam (FIB) of anodes for secondary battery, the anodes for secondary battery being manufactured by using the carbon-silicon composites manufactured by Example 1 and Comparative Example 1.

As shown in FIG. 2, as results obtained by observing the cross-sections cut by focus ion beam (FIB), using a scanning electron microscope (SEM), it could be confirmed in the carbon-silicon composite manufactured by Example 1 that a portion with a low porosity was uniformly formed in the first carbon matrix, such that the silicon-polymer carbonized particles were entirely uniformly dispersed in the first carbon matrix.

Meanwhile, it could be confirmed in the carbon-silicon composite manufactured by Comparative Example 1 that a portion with a low porosity was non-uniformly formed in the first carbon matrix, such that the silicon-polymer carbonized particles agglomerated in the first carbon matrix.

### Experimental Example

Charge and discharge experiments under the following conditions were conducted on secondary batteries manufactured by Example 1 and Comparative Examples 1 and 2.

When it is assumed that 300 mA per 1 g is 1 C, charge conditions were controlled by a constant current at 0.2 C up to 0.01V, and a constant voltage at 0.01V up to 0.01 C, and discharge conditions were measured by the constant current at 0.2 C up to 1.5V.

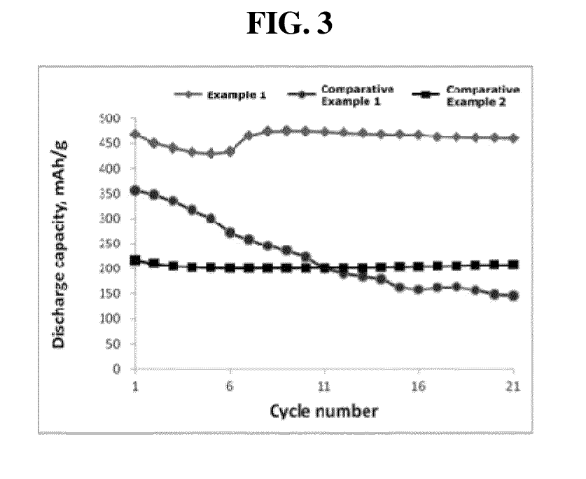

FIG. 3 is a graph showing results obtained by measuring discharge capacity according to the number of cycles on secondary batteries manufactured by Example 1 and Comparative Examples 1 and 2. Table 1 below shows a result of initial charge capacity (mAh/g), and a result of cycle charge capacity maintenance rate (%) after 21 cycles obtained by converting a charge capacity maintenance rate after 21 cycles based on the initial charge capacity, into percent (%).

TABLE 1

| | | Comparative | Comparative |
|---|---|---|---|
| | Example 1 | Example 1 | Example 2 |
| Initial Charge Capacity | 488 | 356 | 217 |
| (mAh/g) | | | |
| Charge Capacity | 97.0 | 40.8 | 95.3 |
| Maintenance Rate (%) | | | |
| After 21 Cycles | | | |

As shown in FIG. 3 and Table 1, as a result obtained by using the carbon-silicon composite comprising the silicon-polymer carbonized particles as the anode active material, it could be confirmed in the secondary battery manufactured by Example 1 that the initial charge capacity was remarkably high and a problem of deterioration in charge capacity after 21 cycles was also remarkably alleviated due to high capacity silicon. Meanwhile, it could be confirmed in the secondary battery manufactured by Comparative Example 1 that the charge capacity after 21 cycles was largely deteriorated, such that a typical problem of deterioration in capacity at the time of using silicon was shown.

Meanwhile, it could be confirmed that since the secondary battery manufactured by Comparative Example 2 did not comprise silicon, the problem of deterioration in capacity according to cycle, caused by silicon, did not seriously occur; however, the initial charge capacity was remarkably low as compared to those of Example 1 or Comparative Example 1.

The above description of the present invention is provided for illustrative purposes, and it will be understood to those skilled in the art that the exemplary embodiments can be easily modified into various forms without changing the technical spirit or essential features of the present invention. Accordingly, the exemplary embodiments described herein are provided by way of example only in all aspects and should not be construed as being limited thereto.

1. A manufacturing method of a carbon-silicon composite, comprising:
(a) preparing a silicon-polymer matrix slurry from mixture comprising a silicon slurry, a monomer, and a cross-linking agent;
(b) performing a heat treatment on the silicon-polymer matrix slurry to manufacture a silicon-polymer carbonized matrix;
(c) pulverizing the silicon-polymer carbonized matrix to manufacture silicon-polymer carbonized particles; and
(d) mixing the silicon-polymer carbonized particles with a first carbon raw material, and then performing a carbonization process.

2. The manufacturing method of claim 1, wherein when it is assumed that a particle diameter at 50% cumulative mass particle size distribution is D50, silicon (Si) in the silicon-polymer matrix slurry in (a) satisfies 2 nm<D50<180 nm.

3. The manufacturing method of claim 1, wherein the monomer in (a) is at least one selected from the group consisting of acrylic add, acrylate, methyl methacrylic add, methyl methacrylate, acryamide, vinyl acetate, maleic add, styrene, acrylonitrile, phenol, ethylene glycol, lauryl methacrylate, and vinyl difluoride.

4. The manufacturing method of claim 1, wherein the cross-linking agent in (a) is at least one selected from the group consisting of ethylene glycol dimethacrylate, ethylene glycol diacrylate, diethylene glycol dimethacrylate, diethylene glycol diacrylate, triethylene glycol diacrylate, tetraethylene glycol diacrylate, N,N-methylenebisacrylamide, N,N-(1,2-dihydroxyethylene)bisacrylamide, and divinylbenzene.

5. The manufacturing method of claim 1, wherein the silicon slurry, the monomer, and the cross-linking agent in (a) have a weight ratio of 10:5˜10:1˜5.

6. The manufacturing method of claim 1, wherein the heat treatment in (b) is performed under an atmospheric pressure at 300° C. to 500° C. for 0.5 to 5 hours.

7. The manufacturing method of claim 1, wherein the silicon-polymer carbonized matrix in (b) has a polymer network structure formed by cross-linking between monomers.

8. The manufacturing method of claim 1, wherein the first carbon raw material in (d) comprises at least one selected from the group consisting of natural graphite, artificial graphite, soft carbon, hard carbon, pitch, calcined coke, graphene, carbon nanotube, and combinations thereof.

9. The manufacturing method of claim 1, further comprising:
(e) mixing the carbon-silicon composite with a second carbon raw material, and then performing a carbonization process.

10. The manufacturing method of claim 9, wherein the second carbon raw material in (e) comprises at least one selected from the group consisting of natural graphite, artificial graphite, soft carbon, hard carbon, pitch, calcined coke, graphene, carbon nanotube, and combinations thereof.

11. A carbon-silicon composite comprising:
silicon-polymer carbonized particles formed from a silicon-polymer matrix slurry comprising a silicon slurry, a monomer, and a cross-linking agent; and
a first carbon matrix,
wherein the silicon-polymer carbonized particles are captured and dispersed in the first carbon matrix.

12. The carbon-silicon composite of claim 11, wherein a mass ratio of silicon (Si) to carbon (C) is 1:99 to 10:90.

13. The carbon-silicon composite of claim 11, wherein the silicon-polymer carbonized particle has a porosity higher than that of the first carbon matrix.

14. The carbon-silicon composite of claim 11, wherein the first carbon matrix comprises at least one selected from the group consisting of natural graphite, artificial graphite, soft carbon, hard carbon, pitch carbide, calcined coke, graphene, carbon nanotube, and combinations thereof.

15. The carbon-silicon composite of claim 11, further comprising:
second carbon particles.

16. The carbon-silicon composite of claim 15, wherein the second carbon particle comprises at least one selected from the group consisting of natural graphite, artificial graphite, soft carbon, hard carbon, pitch carbide, calcined coke, graphene, carbon nanotube, and combinations thereof.

17. An anode for a secondary battery manufactured by coating an anode slurry on an anode current collector, the anode slurry comprising: the carbon-silicon composite of claim 11; a conductive material; a binder; and a thickening agent.

18. A secondary battery comprising the anode for a secondary battery of claim 17.
